(19) United States
(12) Patent Application Publication
(10) Pub. No.: US 2012/0278103 A1
(43) Pub. Date: Nov. 1, 2012

(54) SYSTEM AND METHOD FOR UPLOADING AND SECURING HEALTH CARE RECORDS TO TRUSTED HEALTH-USER COMMUNITIES

(75) Inventors: Joydip Homchowdhury, Round Rock, TX (US); Kimberlie Louise Cerrone, San Francisco, CA (US)

(73) Assignee: TIATROS INC., San Francisco, CA (US)

(21) Appl. No.: 13/449,808

(22) Filed: Apr. 18, 2012

Related U.S. Application Data
(63) Continuation-in-part of application No. 13/096,887, filed on Apr. 28, 2011.

(51) Int. Cl. G06Q 50/24

(52) U.S. Cl. 705/3

(57) ABSTRACT

Systems and methods of uploading image files of sensitive documents are disclosed to at least one trusted community of users. The trusted community may be an automated care pod used by medical providers to treat a patient. The image files may comprise the individual's patient records. A request for uploading may be made to the care pod and the care pod may generate a unique identifying symbol which is sent back to the sender. The care pod or managing system may receive the image file with the unique identifying symbol embedded or associated with the image file. In another embodiment, an automated extractor/verifier may process the uploaded image data and extract user information. Said extracted user information may then be compared against patient information associated with the care pod. If extracted information and patient information do not match, an error flag may be sent.

### CROSS-REFERENCE TO RELATED APPLICATIONS

This Patent Application is a Continuation-in-Part (CIP) Application, and claims the benefit of, a co-pending application with a Ser. No. 13/096,887 filed by common Inventors of this Application on Apr. 28, 2011. The disclosure made in the application Ser. No. 13/096,887 is hereby incorporated by reference in its entirety.

### BACKGROUND

Healthcare providers waste significant time and money when trying to coordinate the exchange of information and medical records about a patient. Most doctor offices deal with paper records which they fax (or otherwise scan and send digitally) to share patient information and patient medical records between offices. In the case of faxing, the procedure of faxing requires coordination between staff of the two doctors' office that includes multiple phone calls, emails etc. After the faxes are received, they need to be collected, organized, filed physically or manually scanned into electronic medical record—that is, if the office uses electronic records. This procedure is typically time consuming, prone to errors such as misplacement and may result in loss of, or compromised privacy of, paper documents. A similar set of procedures and consequences may apply with scanned and electronically sent patient records.

### SUMMARY OF THE INVENTION

Several embodiments of the present invention comprise systems and methods of uploading image files of sensitive documents are disclosed to at least one trusted community of users. The trusted community may be an automated care pod used by medical providers to treat a patient. The image files may comprise the individual's patient records. A request for uploading may be made to the care pod and the care pod may generate a unique identifying symbol which is sent back to the sender. The care pod or managing system may receive the image file with the unique identifying symbol embedded or associated with the image file.

In another embodiment, an automated extractor/verifier may process the uploaded image data and extract user information. Said extracted user information may then be compared against patient information associated with the care pod. If extracted information and patient information do not match, an error flag may be sent.

Other features and advantages of the present system are presented below in the Detailed Description when read in connection with the drawings presented within this application.

### BRIEF DESCRIPTION OF THE DRAWINGS

FIG. 1 shows a high level block diagram of a possible set of trusted users and possible modules for a system built in accordance with the principles of the present invention, and more particularly for medical applications built upon the system.

FIG. 2 depicts the concept of a social pod as made in accordance with several of the present embodiments.

FIG. 3 shows a flow chart of one embodiment of creating and authenticating a social pod within the context of a medical application.

FIG. 4 is a high level block diagram of a system architecture built according to the principles of the present application.

FIG. 5 shows a flow chart of one embodiment of a multimedia content engine as made in accordance with several of the present system embodiments.

FIG. 6 is one embodiment of a present system as built and hosted using existing network infrastructure.

FIGS. 7A and 7B show one embodiment of a present system as built for the treatment of PTSD for returning military veterans.

FIGS. 8A and 8B show one embodiment of a de-identifier module to de-link information within communications of the social pod that contains certain data that might identify patients receiving treatment.

FIG. 9 depicts one embodiment of a screen shot showing the functionality of a treatment plan set up for a patient by a physician.

FIG. 10 shows one embodiment of a program funding module that enables administrators of a social pod to raise funds for programs via the present system.

FIG. 11 depicts a typical transaction that might occur between two physicians whereby one physician refers a patient to a second physician and faxes the patient's medical records to the second physician.

FIG. 12 is one embodiment of a system and/or method of automatically and securely upload medical records or other sensitive documents to a CarePod.

FIG. 13 is one embodiment of a system and/or method of automatically extracting and/or verifying patient data from image files and securely associate such data and/or metadata with the patient's CarePod and associated records.

### DETAILED DESCRIPTION

### Introduction

As hospitals and other HCPs promulgated internal regulations in response to the requirements of laws and regulations of HIPAA, one embodiment of the present invention helps HCPs comply with their internal regulations by providing for a networked system and method of managing the communications among a number of “trusted” users—e.g. by and between a physician and a patient.

In one embodiment, the present system comprises a versatile cloud computing software platform where doctors and researchers may use contemporary social networking tools to communicate with patients and the extended care team online, on tablets and via mobile phones, sharing personal health information and medical records within a HIPAA privacy and security compliant environment. The present system may be constructed as a rule-based computing system that insures that all trusted users and their interactions are compliant to federal, state and their own non-governmental (e.g. university, corporate or the like) privacy and security requirements. The present system should also be flexible to allow users (i.e. HCPs, issue groups or the like) to create specific on-line communities to address particular conditions, diseases or other health-related conditions or issues.

In another aspect of the flexibility, one embodiment of the present system should be to have the system available to users online, on tablets, and on mobile phones. This may be desirable in order to ‘cross the digital divide’ that separates low-income user/patients who do not have high-speed Internet access from health care and support services from which they may otherwise be excluded.

In one aspect, it is desirable to construct the present system in a versatile manner. For example, the present system may be used to construct and support many different types of specific-purpose online communities. The present system may incorporate one or many different types of social networking tools, including audio and video blogging and video chats, and other known types of synchronous and asynchronous communications. As literally hundreds of millions of Facebook, LinkedIn and Twitter users already know how to use social networking technology, the present system incorporates a suite of easy-to-use social networking functions, including audio and video blogging, text messaging and video chats, within a HIPAA-compliant online platform. This, in turn, greatly expanding the ability to connect clinical services to patients (and research studies to research subjects) in novel ways, remotely, cost-effectively, synchronously and asynchronously.

In addition, it is desirable that the present system incorporate content files into such communications—e.g. audio, video, medical application and any other commonly used documents or applications. The present system handles content files of any size, and content files that are created in virtually any underlying application, including the commonly used document, audio, video and specialized medical applications. It may be desirable for the present system to accurately preserve the fidelity of such files and records. The ability to use and share information and medical records within specific purpose communities creates the opportunity to develop new and efficient ways of using it.

In addition to the features listed above, it may also be desirable that the present system include other contemporary technologies to improve the user experience. For example, the use of avatars and other gaming technologies may increase the appeal of programs for some users, while other technologies may improve the user experience for veterans who are blind or hearing impaired.

### Trusted Communities and/or Social Pods

In one possible aspect, the present embodiment may require that the physician communicate with a patient who is authenticated at the time of communication to the patient. In addition, the system stores and/or otherwise archives the interaction between the physician and the patient to form a part of the latter's EHR.

In another possible aspect, the present system may define a set of “trusted” users of the network. Such trusted users may need to be authenticated to establish their level of engagement and interaction with the system. Such authentication may be accomplished by any known method, manner or system for such authentication. Examples include password protection, challenge-response interactions, biometrics or the like.

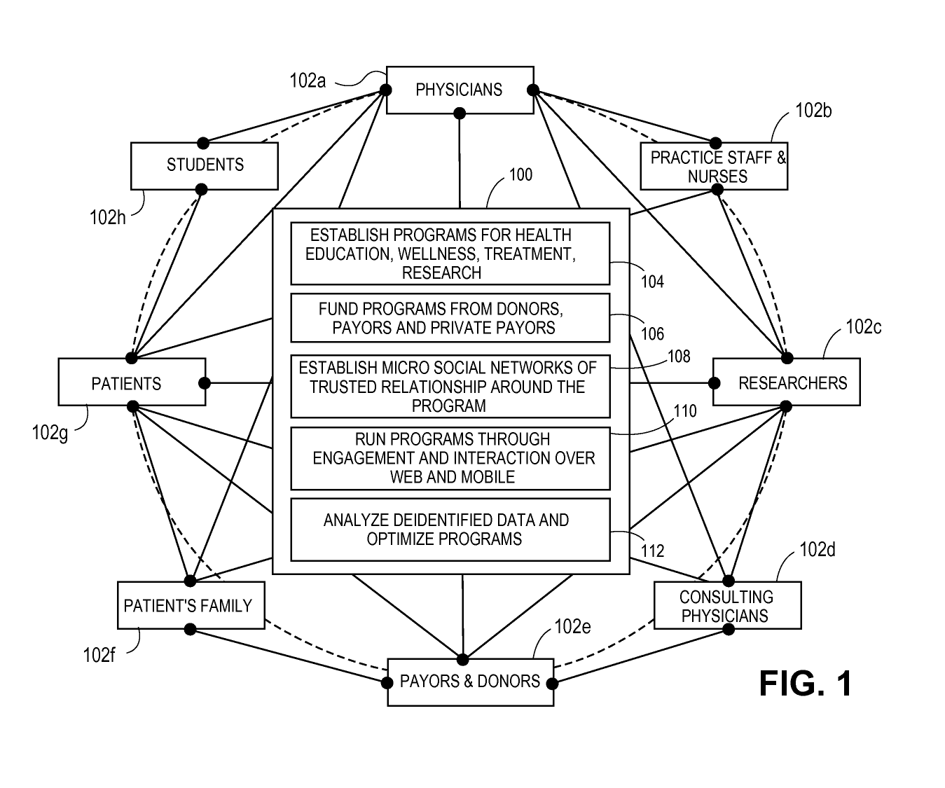

FIG. 1 describes a set of entities that might comprise a prototypical environment of trusted users. Users (collectively labeled 102) are shown interconnectedly with the present system 100 and, possibly, connected amongst themselves apart from system 100. A set of users might comprise the following types of individuals: physicians 102a, practice staff and nurses 102b, researchers 102c, consulting physicians 102d, payor and donors 102e, patient's friends and family members 102f, patients 102g and students 102h.

Each of the users 102 represent entities that may have known communication and computing devices (not shown) in order to affect a networked environment. For example, users 102 may variously have smart phones, cell phones, computers, tablets and the like that may be configured to run a secure, encrypted software environment, as might be presented in a browser or in any other known interfaces. It will be appreciated that the present system encompasses the use of all known devices and means of networked communication that would facilitate the present system as described herein.

The present system may also allow for easy dynamic management of the social pod. For example, the present system may allow for the addition and/or deletion of members in a seamless manner. To appreciate the flexibility of communities that the present system could enable, trusted communities might comprise one, two, or any number of members depending on their specific purpose. For mere exemplary purposes, communities may consist of:
a single member using a self-directed therapeutic intervention
doctor+doctor
doctor to pharmacy
doctor to health insurance agent, e.g., for utilization review
doctor+patient
doctor+patient+family
doctor+entire care team
patient+entire care team
doctor+multiple patients or multiple families
research team
research team+participants
wellness program enrollees
medical-educational program enrollees

The identity of every participant in a community may be authenticated using one or more conventional identity authentication methods each time the member signs on to the community or accesses a content file. The present system may incorporate a variety of conventional authentication methods; the specific method(s) used to authenticate the members of a given community may vary as appropriate to its specific purpose.

Communities may be moderated, or self-directed. One or more moderators may oversee some types of programs, being able, for example, to add new members, remove objectionable content, and update content files. Other types of programs may be completely unsupervised and self-directed.

Because the present system may ensure HIPAA privacy and security compliance, communications and medical records that contain personal health information may be shared among members of the community, synchronously and asynchronously, online and on tablets and mobile phones.

In addition to setting up and populating trusted communities, the present system may use a number of technical strategies to pre-set and enforce access rights to ensure the privacy of communications, and appropriately limit access to certain files. Easy-to-use and redundant methods assure that the moderator(s) exercise complete and dynamic control over which communications and medical records, or parts thereof, are available to everyone, and which are available only to a certain subset of the community.

System 100 may comprise a set of networked computers and/or processors—in communications possibly with computers, processors or mobile devices that are in the possession or under the control of the users 102. There are many desirable and optional features that system 100 provides to users 102 and to the various HCP that are connected to the users.

For example, system 100 may provide the following:
(1) establish networked infrastructure for programs for health, education, prevention, wellness, treatment and/or research (104);
(2) enable automated and/or distributed funding of programs from donors, granting organizations, payors and private payors (106);
(3) establish micro social networks of trusted relationships around the program;
(4) run programs through engagement and interactions over networks (e.g. intranets, the internet or the like) and mobile devices; and
(5) analyze de-identified data that flows through system 100 and optimize programs that are made in accordance with the present system (112).

One embodiment of analysis and optimization of the present system provides that the interactions of involving users and the present system provides a feedback mechanism to sharpen and improve the effectiveness of the system for treating or servicing its users. For example, one embodiment of the present system might be a Clinical Care and Education program that allows providers several means to capture the data about the effectiveness of their programs. The “social” interactions inherent in the solution may be captured by the system, for example as unstructured data. The built Query—Response service allows the system to get explicit feedback in a secure fashion. In addition, the Therapeutics module might allow the system to capture responses from their patients and participants e.g. level of pain, mood, etc., along with compliance data such as “Did you take all three dosages of the medicine, on time” etc. This data set allows the system and its designers (which could be the clinicians and researchers of the program itself) to look for correlation among a particular protocol and its effectiveness and make changes to their programs, be it therapeutics or course material, style of presentation, etc.

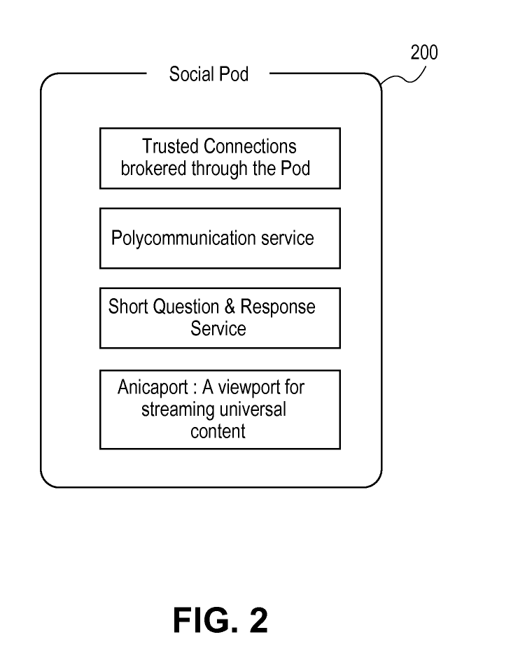

System 100 may be employed to create a networked “microcommunity” of users—a construct called a “social pod”. FIG. 2 depicts a social pod 200. Social pod 200 is enabled or otherwise hosted by system 100 as a set of interconnected computers, processors, mobile devices or the like. Desirable features of social pod 200 may include: a set of trusted connections brokered through the system; a polycommunication service (e.g. email, SMS, voicemail or the like); short question and response service; and a viewport and/or an application (called an “anicaport” for purposes of this application, as described below). This anicaport may act, at a high level, as a viewport for downloading, uploading, and/or streaming of content. Such content may be placed into appropriate formatting and made available to all or a subset of trusted users, possibly in some universal format. In one embodiment, a social pod may provide a restricted and secure way for a micro community of people organized around a specific outcome (e.g. clinical research, treatment of a medical condition, education for wellness etc.) to interact, collaborate, capture structured data, etc.

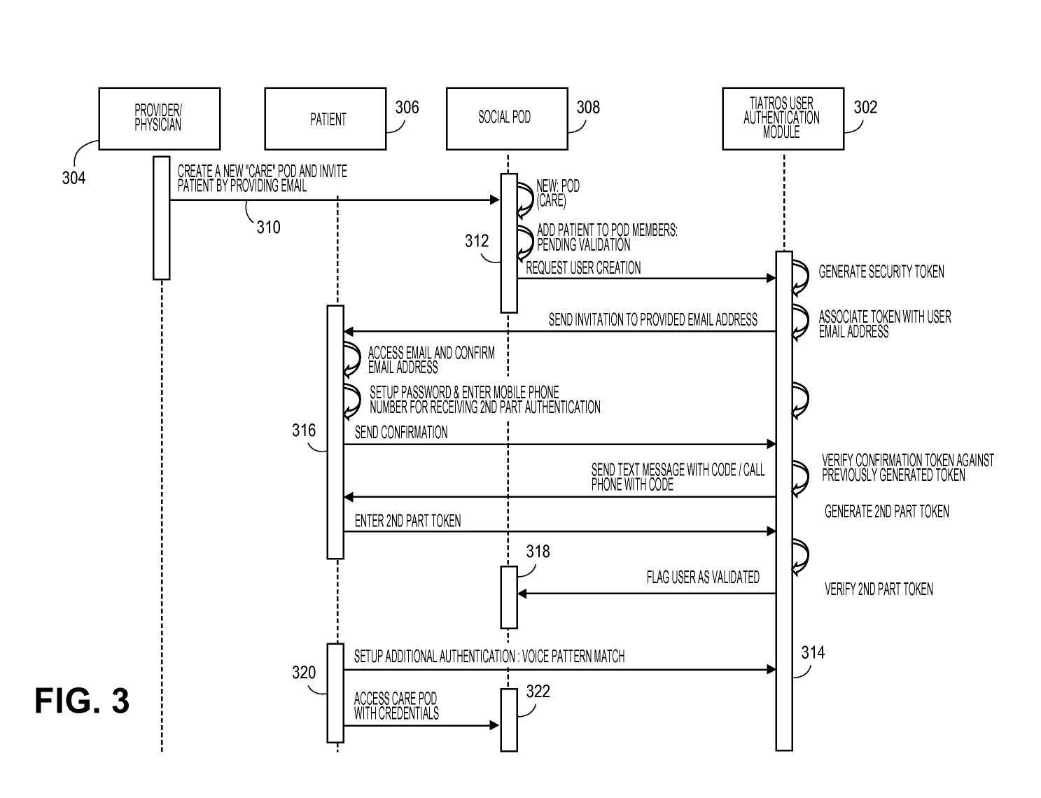

FIG. 3 depicts one embodiment of a method of creating a social pod. In this embodiment, the system may allow for a multi-part authentication procedure and mechanism. It will be appreciated, however, other mechanisms—with varying levels of authentication—may be set up and managed. It will be appreciated that the following description is merely by way of example and that other mechanisms and methods may be employed to created trusted communities and/or social pods.

Social pod 308 may be created by a provider, a physician or researcher 304 via the present system. Provider 304 alerts the system that a new “Care” pod is to be created and provider 304 may populate the pod by listing individuals (e.g. patient 306) and have the system invite patient 306 via some identified means of communication (e.g. by providing the patient's email address to the system) at 310. The system may manage social pod 308 as a set of data structures and/or routines to affect its creation and dynamic management. At 312, the system (via social pod 308 or the like) creates the new “Care” pod and adds patient 306 as a pod member, pending authentication. Pod 308 may then request the system to create patient as a User—in this example, via a request to the system's authentication module 302.

Authentication module 302 may perform such actions as shown at 314. To wit, module 302 may generate a security token and associate the token with the user's email address or any other identifier. Module 302 may return an invitation to the identified email address of the putative new user/patient 306. Patient 306 may then (at 316) access her email and confirm the address, setup a user password and enter other means of communication for the system (such as mobile phone number or the like). This other means of communication may be used to receive a second part authentication for the user. Once initial confirmation is received from patient 306, module 302 may confirm the token against the previously generated token (at 314) and send a text message to the mobile phone (or call the phone directly) with a second part token. Patient 306 may enter the second part token and return to module 302 for further authentication. If module 302 confirms the second part token, module 302 may signal to pod 308 that there is a trusted individual/user at 318.

Additional authentication means may optionally be set up, as desired. For example patient 306 may set up a voice recognition match for further authentication at 320, back to module 302. As time goes forward, patient 308 is then considered a trusted user and may access the pod with suitable credentials at 322.

In one embodiment, the present system may provide flexibility in setting up trusted relationships. For this, it may be desirable to establish that the forms of identifications provided by the user are indeed accessible by the user. For this, the present system may establish such multi-part authentication mechanism as desired. In addition, the administrators or providers of the system can choose the levels of authentication required for trusted users, with a basic minimum possibly designed.

### System Architecture

Having described one aspect of the present system—i.e. the notion of trusted users and the social pod, one or more suitable architecture embodiments for the construction of the present system will now be described. In addition, it will be shown how one embodiment of the present system may leverage existing internet and other infrastructures for efficient build-out of the present system.

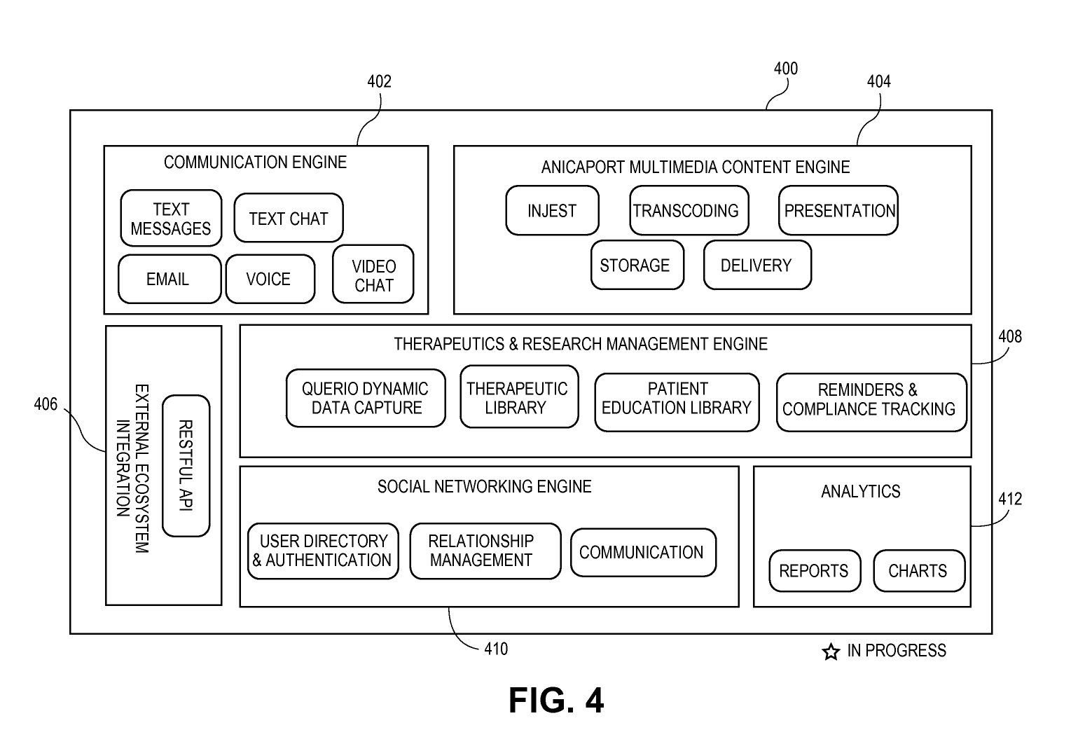

FIG. 4 depicts one embodiment of an architecture of a system that may perform in accordance with the teachings of the present invention. System 400 may advantageously comprise multiple modules for the creation and dynamic operation of the present system. Such modules may comprise the following: communication engine 402, multimedia content engine 404, external ecosystem integration module 406, therapeutic and research management engine 408, social networking engine 410 and analytic engine 412. Each module/engine will be discussed in turn below.

Communication engine 402 is the part of system 400 that comprises sufficient hardware and logic to setup and dynamically manage the flow of communications between trusted users of the present system. Communication engine 402 may manage communications from disparate means and modes of communications—e.g. text messages, chat, email, voice, video chat and the like.

Multimedia content engine 404 is that part of the system 400 that comprises sufficient hardware and logic to create, store, disseminate and dynamically manage the flow of data in and out of system 400 by and to trusted users of the system. Submodules of engine 404 might advantageously comprise: injest submodule, transcoding submodule, presentation submodule, storage, and delivery submodules.

External ecosystem integration engine 406 may present a set of RESTful API, that allows it to exchange its data with third party systems and using (when applicable) industry standards such as HL7 etc. These API's will allow external systems to send information to the present system, e.g. a medical device or EHR system.

Therapeutics and Research Management Engine 408 is that part of the system 400 that comprises sufficient hardware and logic to create, store, disseminate, and dynamically manage treatment plans and pathways for trusted users on the system. It may be desirable for each trusted user of the system that is actively being treated via system 400 to be tracked by engine 408 and their progress logged and processed. Submodules of engine 408 may advantageously comprise: querio dynamic data capture submodule, therapeutic library, patient education library, and reminders and compliance tracking submodule.

Social networking engine 410 is that part of system 400 that comprises sufficient hardware and logic to dynamically manage the various communications and relationships between trusted users of system 400. It should be appreciated that any known combination of processors, data structures, storage and communication media—including transport of data across networks, intranets, the internet—may be utilized to affect the implementation of the present system, as is known to one skilled in the art.

One aspect of the present system is the ability to transcode, store, deliver and present content of a variety of media types. This would be desirable in any number of applications and context—and one such application is in the field of healthcare where patients may thrive better in a treatment program where use of multiple means of communications and messaging (both synchronous and/or asynchronous) may be applied. For example, a patient may not feel like talking directly to a doctor, or writing a lengthy email about conditions and results; but the patient might be amenable to uploading an audio or video file describing such. So, users and applications can use a multimedia content server/network—such as “anicaport” to affect solutions.

It may also be desirable to create an anicaport in such a way as to build solutions that may have shared content; but it is not desired to transmit the files multiple times. With Anicaport, content files of practically any size can be shared. The content files that are authored in native formats may be uploaded and shared, anicaport may transcodes them to ensure that files will display in Web browser or Mobile device without the need for additional software. In addition, content files may be streamed and transmitted over secure, encrypted protocols and designed to be accessible from anywhere on the globe.

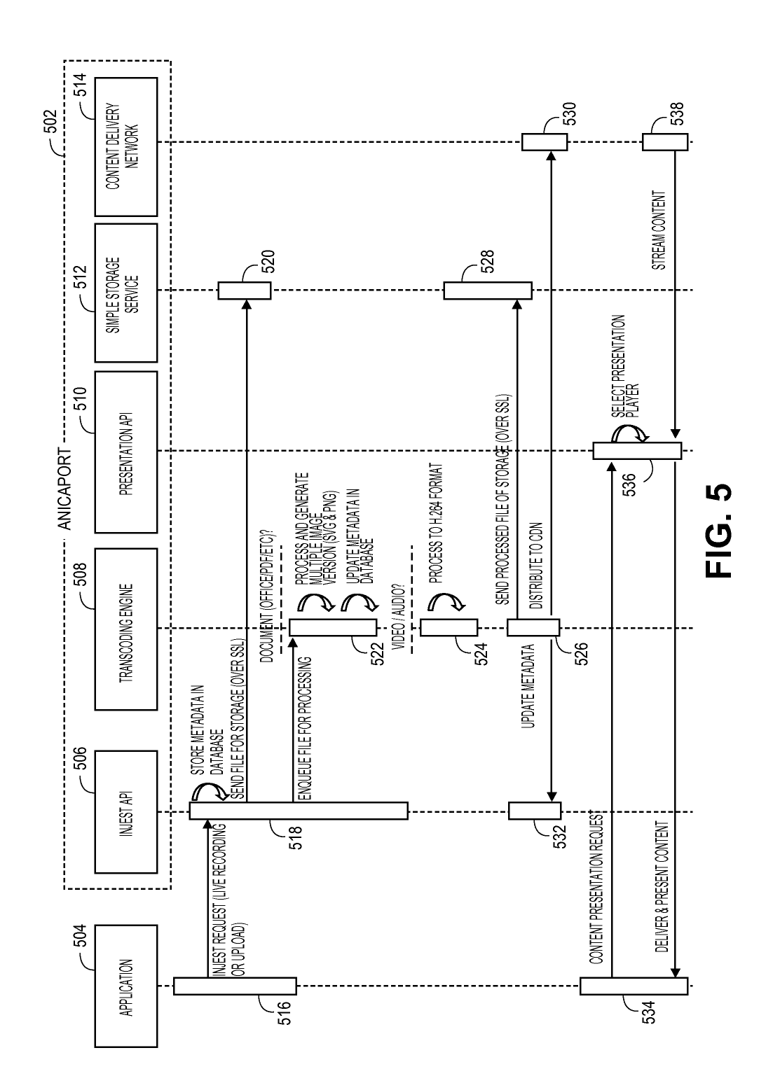

FIG. 5 show one flow chart of the multimedia content engine (“anicaport”) in dynamic operation. Anicaport 502, in this embodiment, comprises injest API 506, transcoding engine 508, presentation API 510, storage 512, and content delivery network 514. Some application (under user control or otherwise) 504 may make an injest request at 516—e.g. a live recording or upload or the like. Injest API 506 may, at 518, store any metadata (if any) in storage or database and send the file associated with the request to storage 520.

This file or data may be queued for further processing at 522 and/or 524, if needed. If the file or data is a form of a document (e.g. office, pdf, etc.), then transcoding engine 508 may process and generate one or more versions, perhaps in different formats, such as image format (e.g. SVG & PNG). Any metadata associated with the transcoding, if any, may be updated in a database or storage. If the file or the data is either an audio or video file, then transcoding engine 508 may process it to a different format—e.g. H.264. Any metadata generated there may also be stored as noted.

At 526, transcoding engine 508 may then send the processed data/file to storage (perhaps over SSL) at 528. In addition, the data/file may be distributed to content delivery network at 530. If there is any update that is needed to earlier saved metadata, it may be accomplished at 532.

Over time, the same or different application 504 may make a request for a presentation of stored content (to which the user or owner of the application has rights to) at 534. Such request may be made to a presentation API 510, which then may select a presentation player at 536 and initiated streaming content at 538 from content delivery network at 538. Presentation API may then oversee such streaming data to application at 534. All of this may be accomplished with the anicaport or other parts of the system checking and enforcing authorizations and permissions—matching users/applications to content.

One embodiment of code that implements an anicaport is shown immediately below. It will be appreciated that many different implementations are possible and are contemplated within the scope of the present invention.

### System Infrastructure

While the architecture of the present system presents one embodiment for the various modules that may be desirable in such a system, the present system itself may be hosted in a myriad of ways, to include leveraging existing infrastructures and the different companies that may provide services and hardware for such hosting and infrastructure.

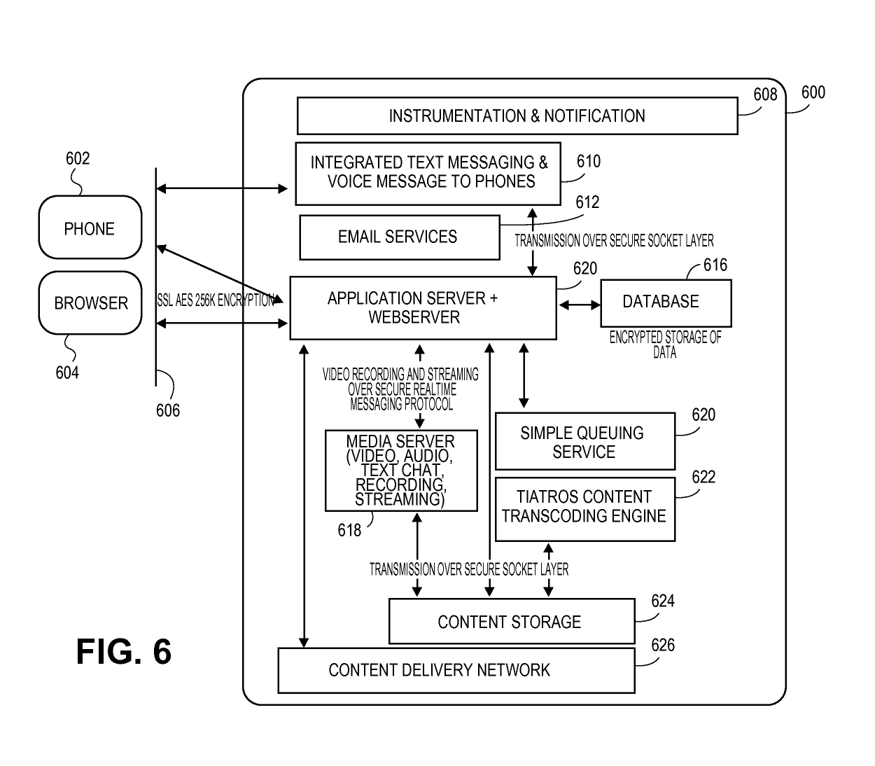

FIG. 6 depicts one embodiment of the present system (600) as it may be hosted over existing infrastructure. Users of the present system may connect by a myriad of communication pathways. For example, users may connect via phone (602), mobile or otherwise, and by a browser 604 through standard interfaces 606. Once connected to the present system 600, the various modules of the present system may be a set of separately hosted modules that are in communication with one another.

The embodiment depicted in FIG. 6 has modules—instrumentation and notification module 608, integrated text and/or voice messaging 610, email service 612, application server and webserver 614, database 616, media server 618, simple queuing service 620, content transcoding engine 622, content storage 624 and content delivery network 626—interconnected in a manner in which each module may be separately hosted, or a set of such modules may be resident on a single site and/or processor.

In one embodiment, the present system may be built on top of best of breed infrastructure available from existing companies—e.g. database hosting services and cloud computing services. It may be desirable that the communication framework of the present system integrates with media servers, SMS gateways and voice capabilities.

In operation, content transcoding engine 622 may convert content files that are uploaded to content storage 624 in any format, e.g., Microsoft Office documents, pdf files, and various image and video formats, preparing them for direct preview and streaming delivery to computing devices, tablet or smartphones (without any downloads). The present system may also advantageously support the sharing of very large image and video content files such as ultrasounds and MRIs. In addition, the present system may also support parallel and separate communication threads among various subsets of a community, ensuring selective and appropriate access to communications, personal health information, and medical reports. The present system may automatically deposit every communication and medical record into a EHR and EMR repository. Notification engine 608 may support therapeutic reminders, workflows and communications.

### Example of Use and Operation

Having described possible architectures and build-out of the present system, it will now be described the uses and operation of an exemplary system, built in accordance with the principles of the present invention.

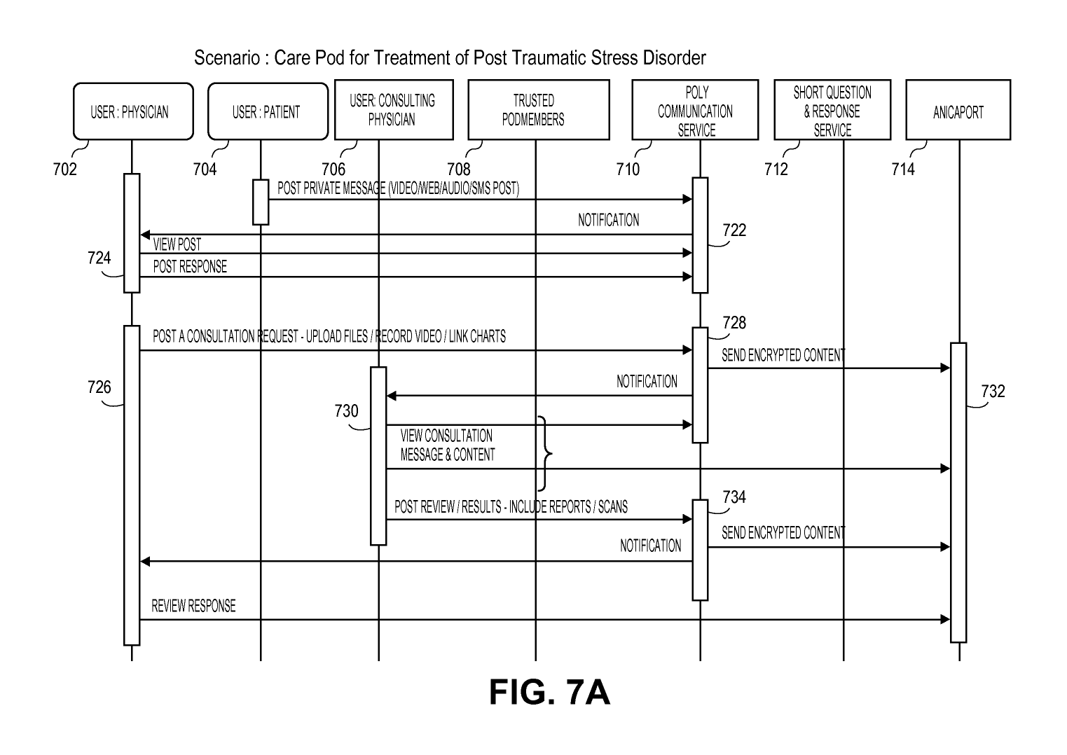

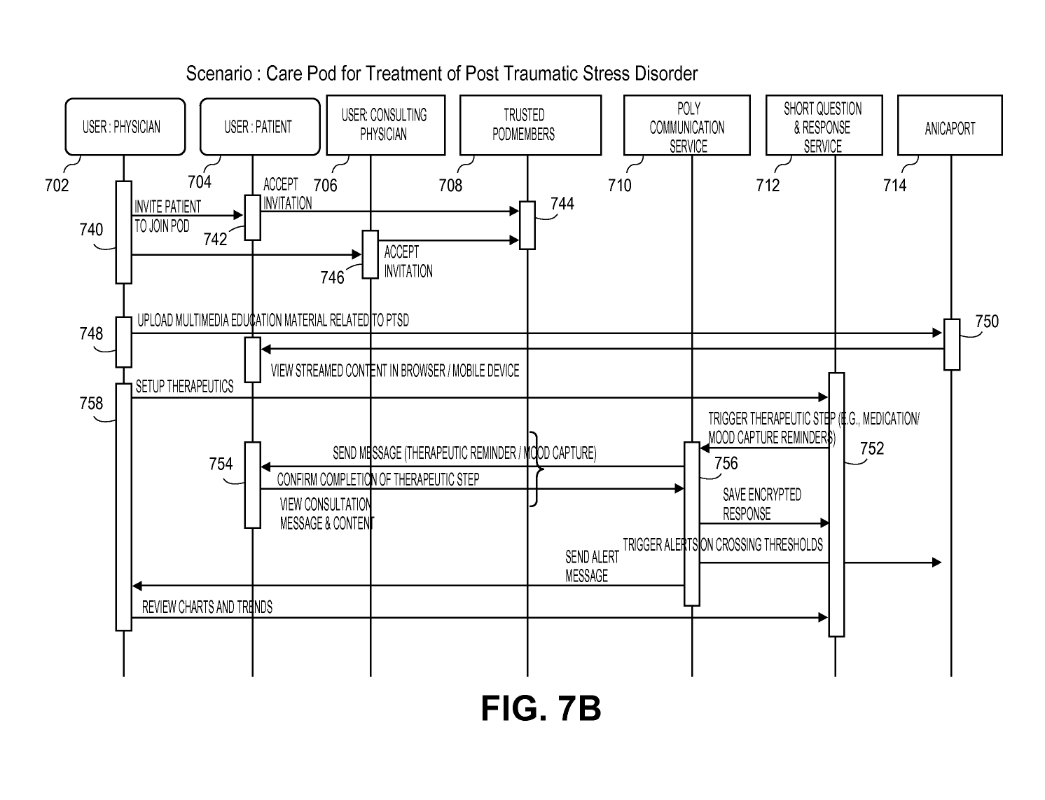

FIGS. 7A and 7B depict the flow of operation of one such embodiment of the present system—i.e. a social pod built and maintained for the management of post-traumatic stress disorder in returning military veterans. It will be appreciated that this embodiment is offered merely for exposition of the present system and does not necessarily limit the scope of invention as claimed below.

In this embodiment, various users may be in communication with other users via and through the present system itself. For example, physicians 702, patient 704, consulting physician 706, other trusted users 708 may be in communication with each other, or various modules of the present system, such as polycommunication service 710, short question and response service 712 and anicaport 714.

In this example, patient 704 may post a private message (at 720, via any known means, e.g. video, web, audio/SMS or the like) meant to be viewed by physician 702. The message may be received by communications service 710 (at 722) and relayed to physician 702 (at 724). Physician 702 may view the post and respond, which is relayed via communication service.

In following-up, physician 702 may post a consultation request at 726 to communication service 710, from which a notification may be sent to consulting physician 706 and a message sent to anicaport 714 at 732. Consulting physician 706 may view the message and content at 730 and then post results of the review back to physician 702 at 734. Anicaport 714 logs all such communications via encrypted content at 732.

In FIG. 7B, physician 702 may invite a new patient 704 and a new consulting physician 706 (at 742 and 746) to join the social pod (as described above) and accept invitations at 744. In addition, physician 702 may decide at 748 to upload certain educational or training materials relating to PTSD to anicaport 750, which then may be viewed by patient 704 as, e.g. streamable content.

Physician 702 may decide to set up a therapeutic regiment for patient 704 at 750. Short question and response service 712 may be employed at 752 to provide reminders and capture any other relevant data (e.g. mood, clinical results, etc.) from the patient at 754. If any alert is triggered by the crossing of a threshold (either clinically or via answers or non-compliance noted by the present system), then an alert may be generated and sent to physician at 752, 756 and 750. Lastly, physician 702 may review charts and trends of patient 704 at 752.

### De-Identification

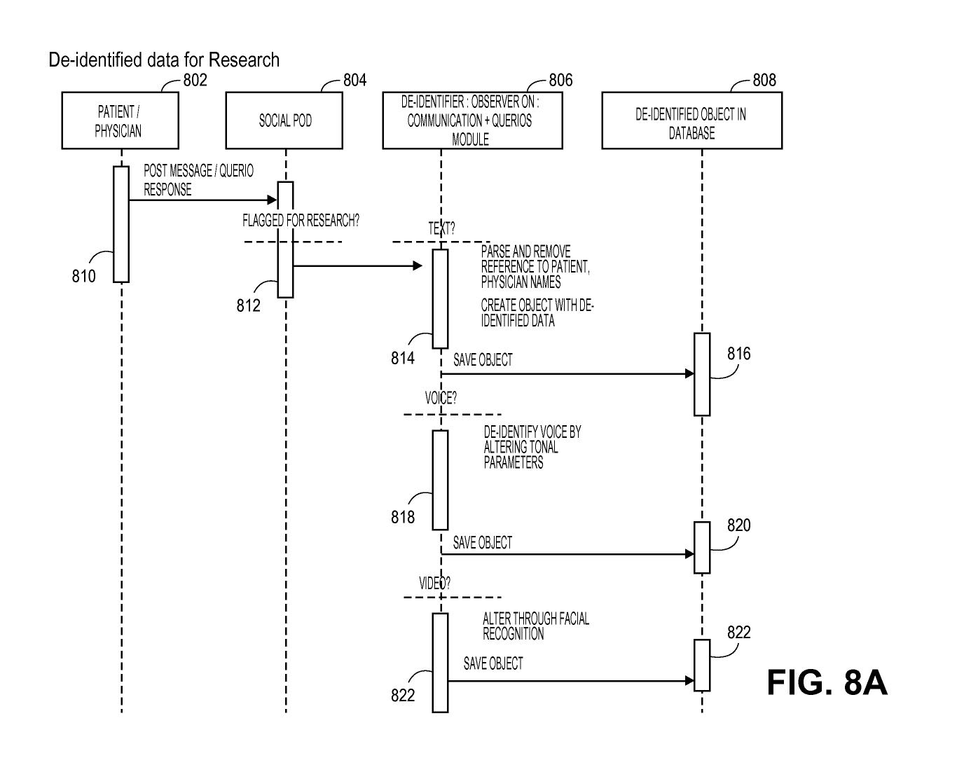

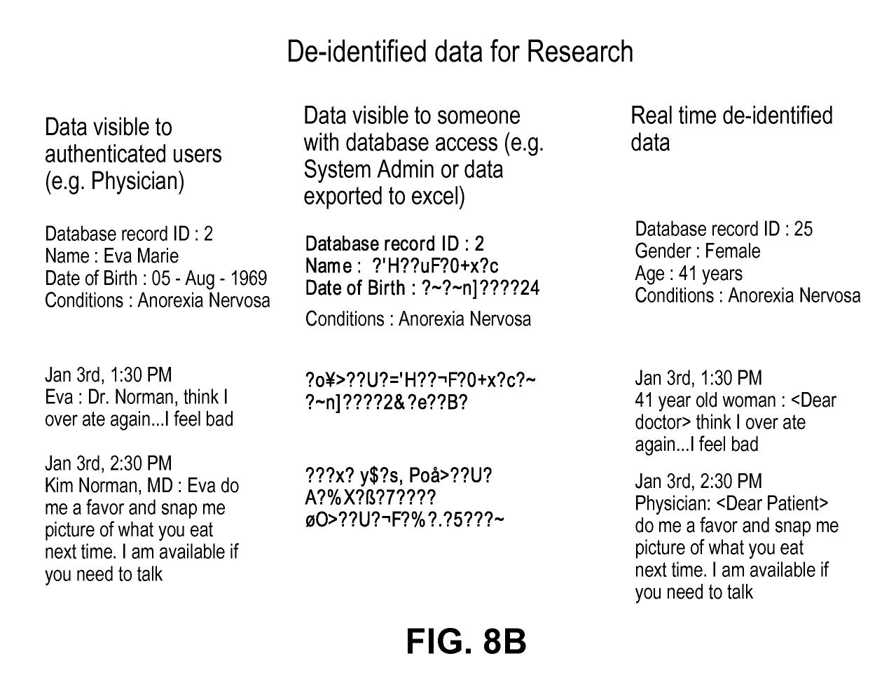

One possible useful feature of a system made in accordance with the principles of the present invention might be the unlinking of patient data from the positive identification of the patient herself. As HIPAA requires that PHI be disseminated in a controlled fashion, FIGS. 8A and 8B depict one embodiment of such a de-identification module.

As noted above, various users of the social pod may be communicating with other users or the system via its interfaces. In this example, physician 802 may be communicating with social pod/system 804. De-identification module 806 may be implemented within the system on top of, or in communication with, query module or communication module or the like. In response, de-identification module 806 may strip out information or data which may be linked to, and help identify, any given patient.

At 810, physician may post a message or a response to the social pod. Such a message, as noted above, may be posted in various forms (e.g. text, voice or video), and it may be desirable that de-identifier module 806 strip out any such identifying data. At 812, such information passed to the social pod 804 may be captured by de-identifier 806. In the case of text at 814, module 806 may parse and remove references to physician and/or patients and create an object without such references, and subsequently be stored at 816.

In the case of voice at 818, module 806 may perform speech recognition to capture information within the message. In addition, module 806 might use voice altering to de-identify the tonal qualities of the individual leaving the message. In the case of video at 822, module 806 may alter pixel data within an image to obscure facial recognition. In addition, module 806 might alter sound and voice data as noted above.

FIG. 8B depicts data and information as may be viewed by either a physician who is authorized to know the identity of the data to whom it is referring—and to others who are not so similarly authorized. The data which is stripped from the data by the present system is depicted in the third column of FIG. 8B.

In one embodiment, the present system may be constructed to capture de-identified data in real-time for research purposes. For example, actual conversations between Physicians/Researchers and Patients (as well as other structured captured data) are typically stored in an encrypted fashion to protect privacy. This however tends to render the data unusable for search and analysis. In these cases, a social pod may be tagged to be “For research”, in which case, the system logs its data in a de-identified form, with the pertinent information but the identifiable elements removed.

### Therapeutics

The present system may also provide a more comprehensive and high engagement support system for better compliance with a therapeutics module. For example, physicians may easily setup a therapeutic action plan and, for each of the components, associate a basket of supporting materials from their online library or record instructions directly through the webcam. The system, will, if setup, send reminders through one or multiple means such as email, voice call or text messages and may require the patient to confirm.

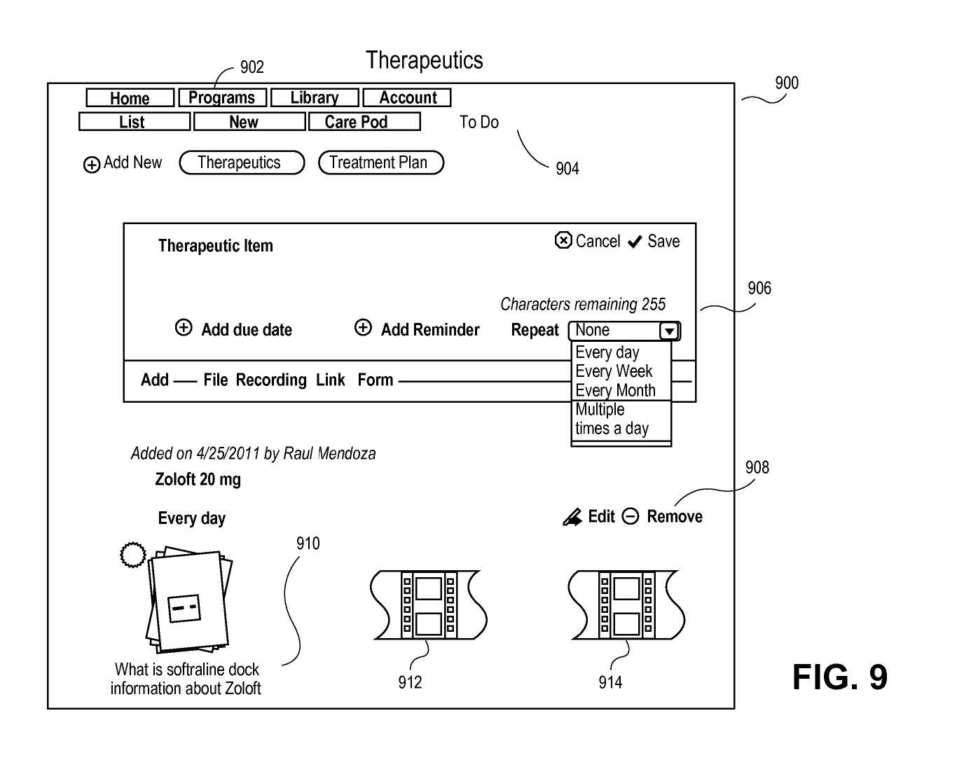

FIG. 9 shows an exemplary screen shot 900 of such a therapeutics interface/module, as may be presented on a web browser or the like. Tabs 902 may be constructed in a user-friendly fashion and, as described above, a To Do tab 904 could be one possible interface to affect a more comprehensive treatment plan for a patient. Possible interfaces might include therapeutic item box 906, where text may be entered by users regarding aspects of the treatment and a set of reminders for treatment may be set in accordance with the treatment plan (e.g. take medications every day, or describe symptoms once a week, take and record vital signs once a month or the like).

In addition, accessible content may be made available through this interface at 908. In this example, the patient has access to a document that describes the medication that she is taking, or the patient may have access to video/audio file 912 that she uploaded to inquire about treatment aspect. Her physician may have responded with a video/audio file 914 in response. Such robust treatment of multimedia content may be delivered as described above.

### Donations and Payments

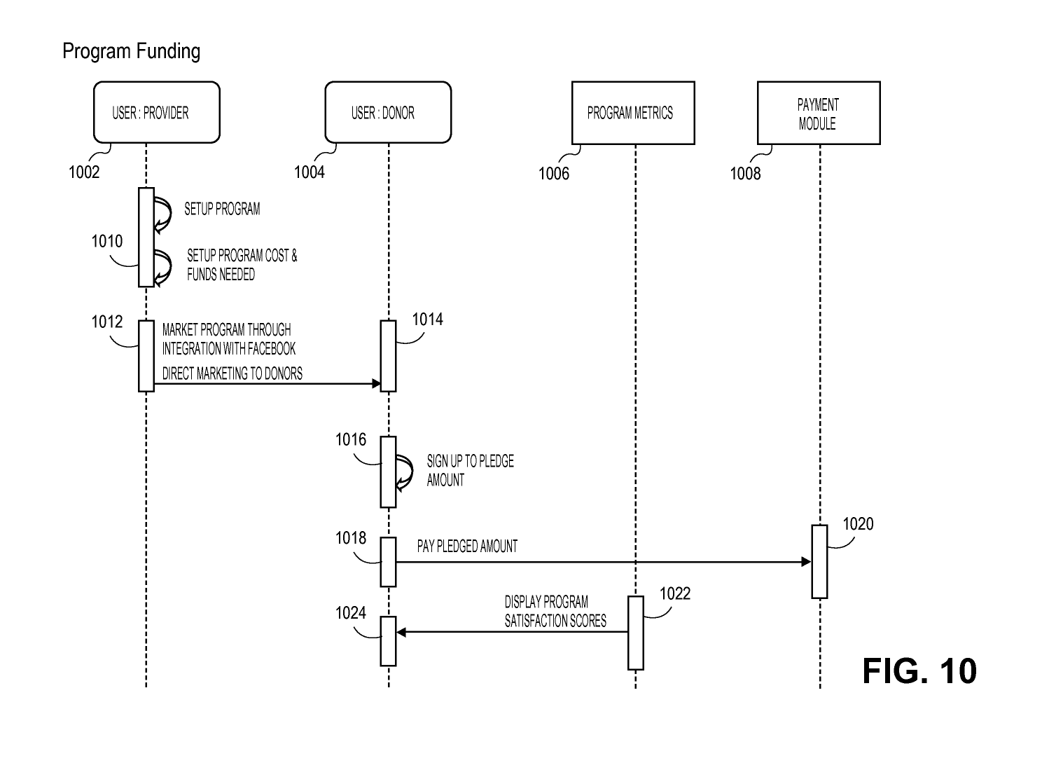

Another aspect of a present system might be a donation and/or payment module that improves the flow of donations and/or payments for programs implemented to address needs of a given social pod. For example, FIG. 10 shows one embodiment of a donation interaction that, in this case, allows providers to raise funds for, e.g., a health outreach program. Donors, in turn, might pledge funds, review outcomes and pay the providers.

Provider 1002 might set up program and outline program cost and funds needed to setup and maintain the program at 1010. Provider 1002 might market such program through any number of channels, e.g. via Facebook or any other social media or outlet at 1012—or market directly to donors. Donors 1004 may receive such marketing at 1014 and pledge some amount at 1016—via the present system. In addition, donors may be made a trusted user and a part of the trusted community, with certain rights and access to materials on the present system. Donor 1004 may make payments at 1018 to payment module 1008 at 1020. To keep the donors informed and engaged, program metrics 1006 may send such metrics—e.g. program satisfaction scores—to donors at 1024, in order for donors to see their donation money at useful work.

### Overview of Uploading Documents to a Pod

The various embodiments of “Pods” (e.g., “CarePods”, “SocialPod” and the like—the terms may be used interchangeably) described herein (and as further depicted in FIGS. 1-10) create a unique place (e.g., in the “cloud”) that unifies communication and tools needed to coordinate, manage and provide care to a patient. The CarePod has the ability to provide controlled access to various people involved in the care of a patient within and between Doctor's offices to the various parts of a CarePod, such as the communication tools, the charts and records etc. This capability may allow the parties involved to have a single and common place to go to find the information they need about a patient, even if they are physically distant as well organizationally separated—i.e., they could be part of two different Healthcare providers in two different parts of the world. The charts and records portion of the CarePod, accommodates the storage of records that exists in an electronic form. This provides the opportunity for healthcare providers to upload files that are in electronic form into the CarePod. Several embodiments of the present application herein provide users of CarePods with systems and methods of sharing paper documents by and between these users.

### Embodiments of Paper Records Upload and Sharing to CarePods

In reference to the discussion below regarding Pods and CarePods (and as further discussed in reference to FIGS. 1-10), it will now be described various embodiments of the uploading and sharing of paper documents into CarePods.

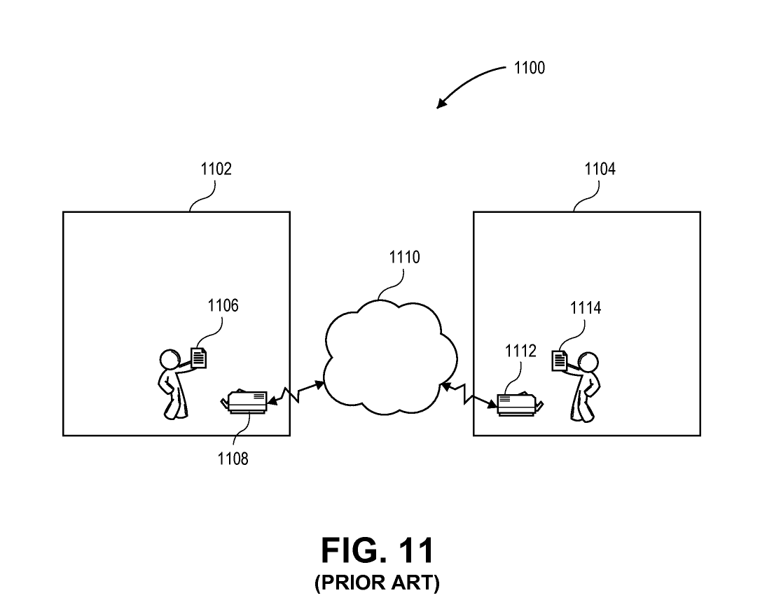

FIG. 11 depicts a typical transaction 1100 by which paper files are shared via facsimile between doctors' offices. Often, a doctor in office 1102 will refer a patient to another physician in a second office 1104. At that time, the patient's record (in paper format) 1106 is faxed 1108 (or otherwise scanned and sent electronically) across by telephone, computer networks—e.g., Internet, or other known means for sending electronic information and received at 1112. Often times, instead of maintaining the patient records in electronic format, another second paper copy 1114 of the patient's records is made at office 1104.

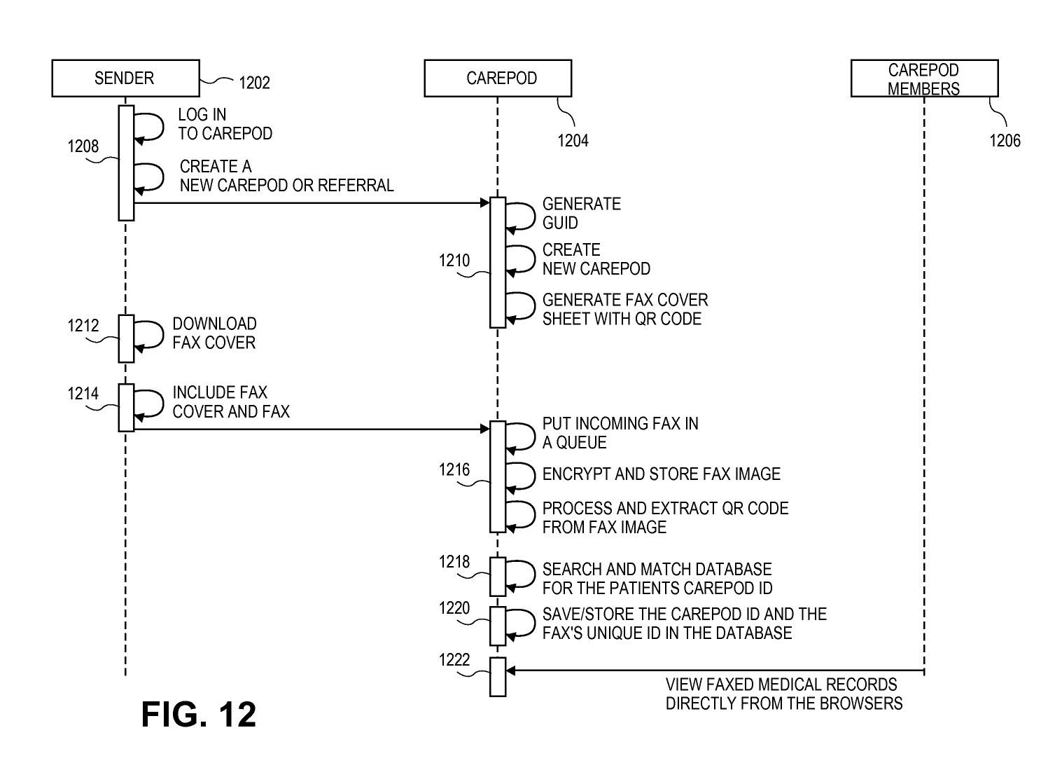

In one embodiment, systems and methods are provided that leverage the trusted and secure nature of the Carepod paradigm and structure to import patient records (usually from paper format) into the Carepod. FIG. 12 shows one embodiment of a flowchart of one such possible system and method. A sender of patient records (Sender 1202) may be a physician, nurse or someone on staff of an office, practice or hospital. Sender 1202 may be a registered user and/or caregiver known to the CarePod (e.g. a trusted user), possibly in relation to a particular patient. If the sender is not yet a registered user, such sender may go through appropriate procedures to be included in the set of registered users.

At 1208, sender 1202 may login to the CarePod. Thereafter, sender may either create a new Carepod—or may create a “referral” for the particular patient at hand. A “referral” may be construed broadly—e.g., to encompass a general practitioner making a referral to a specialist, or a hospital administer making a referral to an insurance company for payment for services rendered. It should be appreciated that such “referrals” encompass the usual and typical transactions that may be made with paper—or unsecured and/or authenticated electronic transactions.

By creating a new CarePod or a new referral, sender sends the Carepod—and/or the computing/communications environment that affects the CarePod—a message at 1210 indicating the intent (e.g. create a referral). This message may be received by the CarePod by a communications module that allows the CarePod to interface with a plurality of devices. Such communication module would be configured to receive such requests for uploading an image file.

Once such a request for uploading is received by the CarePod, systems and/or methods are affected to securing upload such image files, correctly associated with the individual associated with the CarePod. In one embodiment, CarePod 1204 may generate a Global Unique Identifier (GUID) for the message request. If the request was to create a new CarePod, then a new CarePod may optionally be made at 1210. Assuming that the request was to make a referral—and such referral was transfer records in paper format, then CarePod 1204 may generate a cover sheet (e.g. for facsimile or other electronic format transfer) that comprises a unique QR code.

At 1212, sender may download, print or otherwise secure the cover letter (in print or electronic format). At 1214, the cover letter may then be included with the patient record in either paper or electronic format. Sender may then take whatever appropriate technological steps and measures to transmit the patient record (or other suitable record to be secured) to the CarePod.

At 1216, CarePod may queue the incoming facsimile or other electronic transmission—and a sequence of other, optional, steps may then take place. For example, CarePod may encrypt and store the fax image (or other electronic image format). CarePod may process and/or extract the QR code from the image file.

Once the QR code (or any other suitable identifier and/or watermark) is extracted, CarePod may search and match the database for the CarePod associated with the patient and/or individual at 1218. Once the CarePod (or the system that manages multiple CarePods, if more than one CarePod is available to the system) has made the association between the image file and the particular patient or individual in question, CarePod may save and/or otherwise store the image file, together with the unique identifier in the database. In addition, the CarePod may save and/or store the CarePod ID together with the fax and/or image file ID at 1220.

Once the image file has been properly stored in the CarePod's database for a particular patient and/or individual, other member's of the patient's and/or individual's CarePod may view the image file from whatever browser and/or device that is allowable on the CarePod at 1222. Of course, there may be a finer granularity of which particular CarePod members may have access to any particular image file—the rules of authorization and authentication possibly being controlled by the CarePod.

### Automatic Extraction and/or Verification

Once CarePod has stored the image file appropriately for the associated patient and/or individual, it may be desirable to extract the information from the image file on in an automated fashion—and one in which separate (and possibly automated) verification is affected.

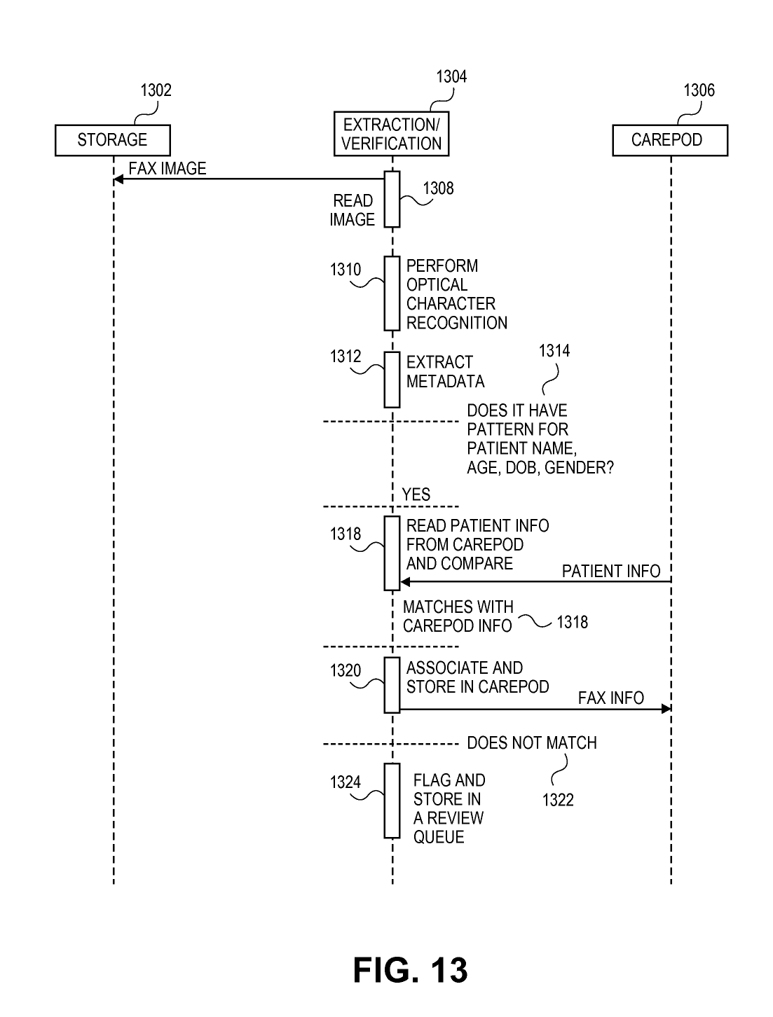

FIG. 13 depicts a flowchart for such an automated extraction and optional verification. Extractor/verifier 1304 may be called by CarePod, users or other executables of the CarePod, once an image file (e.g. fax image) is stored in appropriate storage 1302. At 1308, extractor 1304 may read the image from storage. Once such images are available, extractor/verifier 1304 may perform Optical Character Recognition (OCR) and/or any other known means for extracting information from image files at 1310. Once the image data is now in another format (e.g. ASCII or other computer readable formats), extractor/verifier 1304 may start to extract metadata from the computer readable format at 1312.

At 1314, extractor/verifier 1304 may inquire whether the metadata it is extracting has the “look and feel” of data that such a record may be expected to comprise—e.g. does the metadata contain or otherwise comprise a patient name, an age, a Date of Birth (DOB), gender, etc.? If not, then the extractor/verifier may either terminate its process—or alternatively, alert the CarePod that the image file does not seem to be what it was expecting to extract.

If the metadata falls within the parameter of expected data (e.g. by matching a threshold of expected data, and possibly based on statistical data, heuristics or other rule-based tests), then the extractor/verifier 1304 may read patient data from CarePod 1306 at 1316—as an additional verification that the image file at issue accurately corresponds to the particular patient and/or individual. It should be appreciated that the automated extractor/verifier may be maintained separately from CarePod (e.g. not share information with the CarePod or its storage at this point). Such separation tends to increase the accuracy of the overall system and tends to minimize the possibility that someone else's sensitive information may be inadvertently shared to members of the CarePod.

If the patient information matches at 1318, then extractor/verifier 1304 may then associate and store the metadata (e.g. the computer-readable format, and not image format) in the CarePod at 1320.

Alternatively, if the patient information does not match at this point—or if any other anomaly occurs—extractor/verifier 1304 may set a flag that a problem may have occurred at 1324. As an optional protective measure, the information extracted may be stored separate and away from CarePod access. This would also minimize the possibility that patient confidential information is not compromised.

A detailed description of one or more embodiments of the invention, read along with accompanying figures, that illustrate the principles of the invention has now been given. It is to be appreciated that the invention is described in connection with such embodiments, but the invention is not limited to any embodiment. The scope of the invention is limited only by the claims and the invention encompasses numerous alternatives, modifications and equivalents. Numerous specific details have been set forth in this description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

1. A system for uploading image files to a CarePod, said image files associated with an individual for whom said CarePod is further associated, the system comprising:
a request communications module for receiving a request for uploading an image file from a sender, said request comprising data associated with said individual;
a unique identifier generator module for generating a unique identification symbol, said unique identification symbol being associated said individual and said unique identification symbol being sent to said sender; and
an image file receiving module for the receiving at least one image file, said image file further comprising said unique identification symbol.

2. The system as recited in claim 1 wherein said sender is a trusted user of said system.

3. The system as recited in claim 1 wherein said image file comprises one of a group, said group comprising: a facsimile of a paper file and an electronic image file.

4. The system as recited in claim 1 wherein said unique identifier generator module generates a QR code, said QR code capable of being associated with said image file to be uploaded.

5. The system as recited in claim 4 wherein said image file to be uploaded comprises a facsimile of a paper file and further wherein said QR code is embedded in a cover letter to be appended to said paper file upon facsimile transmission.

6. The system as recited in claim 1 wherein said image file receiving module is capable of receiving said image file and said unique identifier from said sender.

7. The system as recited in claim 6 wherein said system is capable of storing said image file and an associated CarePod ID.

8. A system for automatically extracting and verifying user information from an image file and securely associating said user information with the user's CarePod, said system comprising:
an image file receiving module for receiving image files;
an optical character recognition module, said optical character recognition module reading said image file and transforming said images into computer readable data;
a patient identification feature extracting module for extracting user information from said computer readable data, said user information giving some indication as to the identity of said user; and
a comparison module for initially comparing said extracted user information with an individual CarePod and for storing said extracted user information if said extracted user information matches with information about said individual.

9. The system as recited in claim 8 wherein said image file is a facsimile of a patient's record.

10. The system as recited in claim 9 wherein said extracted user information is one of a group, said group comprising: patient name, age, date of birth and gender.

11. The system as recited in claim 10 wherein said comparison module comprises a threshold wherein said comparison module is capable of comparing said extracted user information with said information about a possible individual associated with a CarePod; and
further wherein if the number of extracted features do not match individual information exceeds said threshold, said comparison module is capable of setting an error flag.

12. A method for uploading image files to a CarePod, said image files associated with an individual for whom said CarePod is further associated, the steps of said method comprising:
receiving a request for uploading an image file to a CarePod from a sender, said request comprising data associated with said individual and said individual further associated with said CarePod;
generating a unique identification symbol, said unique identification symbol being associated with said CarePod and said unique identification symbol being sent to said sender; and
receiving at least one image file, said image file further comprising said unique identification symbol.

13. The method as recited in claim 12 wherein said sender is a trusted member of said CarePod.

14. The method as recited in claim 12 wherein said image file comprises one of a group, said group comprising: a facsimile of a paper file and an electronic image file.

15. The method as recited in claim 12 where the steps of said method further comprise:
transforming said image file into computer readable data;
extracting user information from said computer readable data; and
comparing said extracted user information with information about the individual for which the CarePod is associated.
